(19) United States
(12) Patent Application Publication
(10) Pub. No.: US 2022/0153600 A1
(43) Pub. Date: May 19, 2022

(54) METHOD OF CONTINUOUSLY PRODUCING NANO-SIZED AEI-TYPE ZEOLITES

(71) Applicant: Pacific Industrial Development Corporation, Ann Arbor, MI (US)

(72) Inventors: Yunkui Li, Ann Arbor, MI (US); Wei Wu, Ann Arbor, MI (US); De Gao, Troy, MI (US); David Shepard, Canton, MI (US); Jeffery Lachapelle, Northville, MI (US); Geng Zhang, Utsunomiya (JP)

(21) Appl. No.: 17/433,409

(22) PCT Filed: Apr. 9, 2020
(86) PCT No.: PCT/US2020/027380

§ 371 Date: Aug. 24, 2021

Related U.S. Application Data
(60) Provisional application No. 62/833,947, filed on Apr. 15, 2019.

(51) Int. Cl. C01B 39/48; B01J 19/24

(52) U.S. Cl. CPC C01B 39/48; C01P 2006/12; C01P 2004/03; B01J 19/2415

(57) ABSTRACT

A method of continuously forming AEI-type zeolites in a tubular reactor via a hydrothermal synthesis. A gel composition formed upon using this method includes one or more sources of silica, alumina, organic structure directing agents (OSDA), alkali metal ions; water; and optionally zeolite seeds. This gel composition is defined by the molar ratios of SiO₂/AI₂O₃ 15:1 to 100:1; M₂O/SiO₂ 0.15:1 to 0.30:1; ROH/SiO₂ 0.05:1 to 0.2:1; and H₂O/SiO₂ 5:1 to 20:1; wherein M is the alkali metal ion and R is an organic moiety derived from the OSDA. This gel composition, after reacting at a temperature between 180° C. to about 220° C. for less than 2 hours forms the crystalline AEI-type zeolite having a silica to alumina ratio (SiO₂/AI₂O₃) that is greater than 14:1.

### FIELD

This disclosure relates generally to a method of making an AEI-type zeolite that exhibits a high silica to alumina molar ratio (SAR), the AEI-type zeolites formed according to said method, and the gel compositions formed during and used in the method of making the AEI-type zeolites.

### BACKGROUND

The statements in this section merely provide background information related to the present disclosure and may not constitute prior art.

Microporous zeolites, which contain three-dimensional channels, play an important role in the selective catalytic reduction (SCR) of exhaust emissions arising from diesel engines. An AEI-type zeolite represents one type of aluminosilicate zeolite that may be used as a catalyst support in this application due to its small cage opening size and hence high hydrothermal stability.

AEI-type zeolites may be synthesized using a FAU zeolite as a building unit due to the fast hydrothermal conversion of its double 6 members rings to an AEI-type structure. AEI-type zeolites may also be synthesized using a Y zeolite having a high silica to alumina (SiO₂:Al₂O₃) ratio. However, such a synthetic method is susceptible to the formation of AEI-type zeolites at low yields (e.g., not greater than 25%) and at a high cost due to the use of a large amount of expensive organic structure directional agents (OSDA). This method typically uses a molar ratio of OSDA:SiO2 that is greater than 0.14. Thus, in order to counter the expense associated with the OSDA, the method generally requires reuse of the mother liquid, which contains unused OSDA, in the preparation of subsequent batches.

Conventional hydrothermal synthesis method performed in an autoclave generates AEI zeolites in which the aluminum distribution in the crystal is directly correlated with the amount of time the reaction is at the crystallization temperature. The silica:alumina ratio (SAR) plays a major role in hydrothermal stability exhibited by a zeolite. More specifically, the higher the SAR, the higher the hydrothermal stability. The development of ultrafast synthesis methods for forming aluminosilicate AEI zeolites in which the zeolites exhibit a homogeneous SAR within the crystal structure is desirable.

### SUMMARY

This disclosure relates generally to an inexpensive method of making an AEI-type zeolite using a tubular reactor that has a homogeneous high silica to alumina ratio (SAR), the AEI-type zeolites formed according to said method, and the gel compositions formed during and used in the method of making the AEI-type zeolites.

According to one aspect of the present disclosure, the continuous method of making an AEI-type zeolite comprises the steps of: i) providing a tubular reactor; ii) providing a source of silica; iii) providing a source of alumina; iv) providing an organic structure directional agent (OSDA); v) providing a source of alkali metal ions; vi) providing a source of water; vii) optionally, providing a zeolite seed; viii) mixing the source of silica, alumina, OSDA, alkali ions, water, and optionally, zeolite seed to form a gel composition; ix) allowing the gel composition to enter a tubular reactor; x) heating the gel composition to a crystallization temperature that is in the range of about 180° C. to about 220° C.; xi) maintaining the gel composition at the crystallization temperature for a time period that less than 2 hours; xii) allowing the AEI-type zeolite to crystallize and precipitate; the gel composition forming a crystalline precipitate of the AEI-type zeolite and a mother liquid; and xiii) separating the crystalline precipitate from the mother liquid.

The AEI-type zeolite so formed exhibits a silica to alumina (SiO₂:Al₂O₃) molar ratio of at least 14:1. This method is a hydrothermal synthesis without the use of hydrogen fluoride (HF) that yields the AEI-type zeolite. An NaY zeolite and/or the Y zeolite may provide a portion of the source of the silica in which the silica to alumina (SiO₂:Al₂O₃) molar ratio is >5. An FAU zeolite may provide a portion of the source of the alumina.

An AEI zeolite may be added as a seed in an amount of 0% to about 10% relative to silica present in the AEI-type zeolite. Alternatively, the AEI zeolite seed is present in an amount ranging from 0.01% to about 5%; alternatively, from 0.01% to about 1% relative to the amount of silica present in the AEI-type zeolite.

According to another aspect of the present disclosure, a gel composition is provided wherein after reacting at a temperature between 180° C. to about 220° C. for less than 2 hours forms a crystalline AEI-type zeolite having a silica to alumina ratio (SiO₂:Al₂O₃) that is greater than 14:1. This gel composition is generally comprised of the components of one or more sources of silica; one or more sources of alumina, one or more organic structure directing agents (OSDA); a source of alkali metal ions; and water. The components in the gel composition may be present in the following molar ratios:

| | |
|---|---|
| SiO₂/Al₂O₃ | 15:1 to 100:1; |
| M₂O/SiO₂ | 0.15:1 to 0.30:1; |
| ROH/SiO₂ | 0.06:1 to 0.12:1; and |
| H₂O/SiO₂ | 7:1 to 15:1; |

wherein M is the alkali metal ion and R is an organic moiety derived from the OSDA.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart of a method for preparing an AEI-type zeolite according to the teachings of the present disclosure; and

FIG. 2 is a schematic representation of the tubular reactor utilized in the method of FIG. 1.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the catalyst support made and used according to the teachings contained herein is described throughout the present disclosure in conjunction with a selective catalytic reduction (SCR) catalyst in order to more fully illustrate the composition and the use thereof. The incorporation and use of such an AEI-type zeolite in other applications, such as adsorbents, ion exchange agents, or as a support material used for industrial catalysts and/or environmental catalysts is contemplated to be within the scope of the present disclosure. It should be understood that throughout the description, corresponding reference numerals indicate like or corresponding parts and features.

The present disclosure provides a synthetic method for continuously producing an aluminosilicate AEI-type zeolite having a SiO₂:Al₂O₃ molar ratio (SAR) of at least 14 via a hydrothermal reaction. This method provides an AEI-type zeolite with a homogeneous SAR value throughout the crystal structure. During the synthetic method the use of the organic structure directional agent (OSDA) is limited to an OSDA:SiO₂ molar ratio that is between about 0.06:1 to about 0.12:1. The gel mixture, which includes a source of tetravalent silicon (Si), a source of trivalent aluminum (Al), alkaline metal ion (e.g., Na, K), organic structure directional agent (OSDA), water, and optionally a zeolite “seed”, is allowed to react in the tubular reactor to for the AEI-type zeolite with high speed and homogeneous SAR distribution.

In addition, the resulting AEI-type zeolites are substantially free of fluorine, fluorine-containing compounds and fluorine ions. The synthetic method described herein may be described as a hydrothermal synthesis conducted at an elevated temperature, thereby, making the use of hydrofluoric acid (HF) impractical. The AEI-type zeolite formed according to the method described above and further defined herein is economically feasible for use in most applications. The prior use of conventional synthetic methods of forming the AEI-types zeolites made the use of AEI-type zeolites cost prohibitive for applications, such as a support material for a catalyst in a selective reduction reaction (SCR) of NOx contained in the exhaust gas of a vehicle.

In general, zeolites are crystalline or quasi-crystalline aluminosilicates comprised of repeating TO₄ tetrahedral units with T being most commonly silicon (Si) or aluminum (Al). These repeating units are linked together to form a crystalline framework or structure that includes cavities and/or channels of molecular dimensions within the crystalline structure. Thus, aluminosilicate zeolites comprise at least oxygen (O), aluminum (Al), and silicon (Si) as atoms incorporated in the framework structure thereof.

The notation, “AEI” represents a code specified by the International Zeolite Associate (IZA) that defines the framework structure of the zeolite. Thus an “AEI-type” zeolite means an aluminosilicate in which the primary crystalline phase of the zeolite is “AEI”. In the AEI-type zeolite of the present disclosure, the presence of another crystalline phase or framework structure, such as “FAU”, in the zeolite is absent or nonexistent. In other words, the AEI-type zeolite of the present disclosure is substantially free of other crystalline phases and is not an intergrowth of two or more framework types.

The crystalline phase or framework structure of a zeolite may be characterized by X-ray diffraction (XRD) data. However, the XRD measurement may be influenced by a variety of factors, such as the growth direction of the zeolite; the ratio of constituent elements; the presence of an adsorbed substance, defect, or the like; and deviation in the intensity ratio or positioning of each peak in the XRD spectrum. Therefore, a deviation of 10% or less; alternatively, 5% or less; alternatively, 1% or less in the numerical value measured for each parameter of the AEI structure as described in the definition provided by the IZA is within expected tolerance.

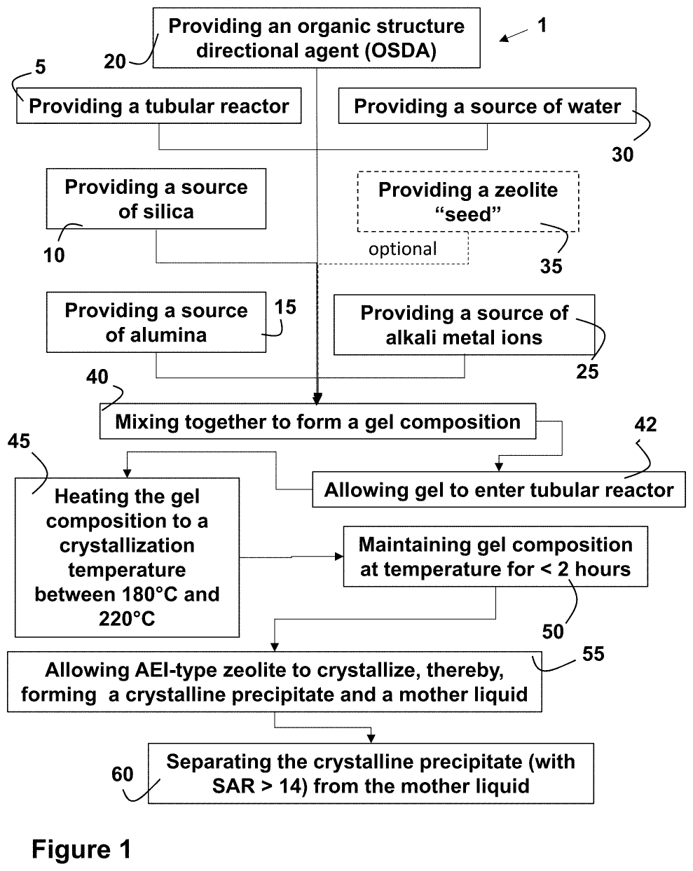

Referring now to FIG. 1, a method 1 is provided for producing an AEI-type zeolite that exhibits a silica to alumina (SiO₂:Al₂O₃) ratio of at least 14. According to one aspect of the present disclosure, the method may use an NaY zeolite or Y zeolite with a silica to alumina (SiO₂:Al₂O₃) ratio of greater than 5 as a partial source of the silica. The method may also use an FAU zeolite as a partial source of alumina. Alternatively, the SiO₂:Al₂O₃ molar ratio (SAR) of the formed AEI-type zeolites is at least 18; alternatively, 22 or more; alternatively, about 25; alternatively, between 15 and 50. The SiO₂:Al₂O₃ ratio exhibited by the AEI-type zeolites may be measured using x-ray fluorescence (XRF) or inductively coupled plasma (ICP) emission spectroscopy.

Still referring to FIG. 1, the method 1 generally comprises the steps of:
i. providing 5 a tubular reactor;
ii. providing 10 a source of silica;
iii. providing 15 a source of alumina;
iv. providing 20 an organic structure directional agent (OSDA);
v. providing 25 a source of alkali metal ions;
vi. providing 30 a source of water;
vii. optionally, providing 35 a zeolite seed;
viii. mixing 40 the source of silica, alumina, OSDA, alkali metal ions, water, and optionally the zeolite seed to form a gel composition;
ix. allowing 42 the gel composition to enter a tubular reactor;
x. heating 45 the gel mixture to a crystalline temperature that is in the range of about 180° C. to about 220° C.;
xi. maintaining 50 the gel mixture at the crystalline temperature for a time period that is less than 2 hours;
xii. allowing 55 the aluminosilicate AEI-type zeolite to crystallize and precipitate from the gel mixture, thereby, forming a crystalline precipitate and a mother liquid; and
xiii. separating 60 the crystalline precipitate from the mother liquid.

The optional zeolite seed represents a small amount of AEI zeolite that is incorporated into the gel composition in order to facilitate formation of the AEI-type framework. The amount of the AEI zeolite used as a “seed” may range in an amount from 0% to about 10% based on the amount of silica present in the gel composition. Alternatively, the amount of the AEI zeolite used in the seeding is between 0.01% to about 5% based on the amount of silica in the gel composition; alternatively, in the range of 0.01% to 1% based on the silica amount. The AEI zeolite that is used as a “seed” may be in a calcined or uncalcined form as determined to be desirable.

The source of silica may comprise, consist essentially of, or consist of sodium silicate, silica sol, fumed silica, tetraethyl orthosilicate, NaY zeolite NaY, and/or Y zeolite that has a silica to alumina (SiO₂:Al₂O₃) molar ratio >5, or a combination thereof. The amount of silica present in the gel composition is determined by the amount necessary for each of the other raw materials to be within the ranges specified herein with respect to the silica in order to provide an AEI-type zeolite that exhibits the desired SiO₂:Al₂O₃ ratio.

The source of aluminum may comprise, consist essentially of, or consist of one or more of aluminum metal, aluminum hydroxide (e.g., gibbsite, boehmite, etc.), aluminum sulfate, aluminum nitrate, FAU zeolite, or a mixture thereof. According to one aspect of the present disclosure, the FAU zeolite may have a silica to alumina (SiO₂:Al₂O₃) molar ratio <5.

The organic structure directional agents (OSDA) that are used in the preparation of AEI-type zeolites are typically complex organic molecules capable of guiding or directing the molecular shape and pattern of the zeolite's framework. Generally, the zeolite crystals form around the OSDA. After the crystals are formed, the OSDA is removed from the interior structure of the crystals, leaving a molecularly porous cage-like structure. The OSDA may include, but not be limited to N, N-Dimethyl-3,5-dimethylpiperidinium hydroxide, N, N-diethyl-2, 6-dimethylpiperidinium hydroxide, tetramethylphosphonium hydroxide, or a mixture thereof. Alternatively, the OSDA is N, N-Dimethyl-3,5-dimethylpiperidinium hydroxide.

The source of alkali metal ions may comprise, consist essentially of, or consist of alkali metal (M) ions, wherein M is selected as sodium (Na), potassium (K), or cesium (Cs). The alkali metal ions may be obtained from sodium hydroxide, cesium hydroxide, potassium hydroxide, or a combination thereof. Alternatively, the alkali metal ion source is sodium hydroxide. The inclusion of alkali metal ions in the gel composition helps to facilitate crystallization by forcing the OSDA to coordinate with aluminum in a preferred state. When a zeolite is to be used as an adsorbent or as a support for a catalyst, alkali metal atoms that are incorporated into the crystal structure of the zeolite during the formation of the zeolite may be removed from within the crystal structure by an ion exchange mechanism. An ion exchange mechanism is capable of replacing the alkali metal ions with hydrogen, ammonium, or any other desired metal ion.

The yield of AEI-type zeolites formed according to this method is greater than about 15% relative to the total oxide present in the gel composition. Alternatively, the yield is greater than 25%; alternatively, 35% or higher; alternatively, greater than 45%. Thus, the method of the present disclosure does not need to reuse the mother liquid as part of the water used to form the gel composition in order to obtain a high yield. However, since the mother liquid contains unreacted OSDA, when desirable, the mother liquid may be used to replace at least a portion of the water in which the raw materials are mixed to form the gel composition. In order to facilitate crystallization and precipitation of the AEI-type zeolite, the amount of water in which the raw materials are mixed 30 (see FIG. 1) is in a molar ratio with silica (H₂O:SiO₂) that is typically at least 7:1 and no greater than 15:1 as further defined below.

According to one aspect of the present disclosure, the gel composition may be further described by molar ratios for each raw material with respect to the amount of silica (SiO₂). These molar ratios include those shown in Table 1, wherein M refers to the alkali metal ions and R refers to an organic moiety derived from the organic structure directional agent (OSDA).

TABLE 1
Raw Material Ratios in Gel Composition

| | |
|---|---|
| SiO₂:Al₂O₃ | 15:1 to 100:1 |
| M₂O:SiO₂ | 0.15:1 to 0.30:1 |
| ROH:SiO₂ | 0.06:1 to 0.12:1 |
| H₂O:SiO₂ | 7:1 to 15:1 |

Alternatively, the gel composition may be described by molar ratios of the raw materials with respect to the amount of silica (SiO₂) may include those provided in Table 2, wherein M refers to the alkali metal and R refers to an organic moiety derived from the OSDA.

TABLE 2
Raw Material Ratios in Another Gel Composition

| | |
|---|---|
| SiO₂:Al₂O₃ | about 20:1 to about 60:1 |
| M₂O:SiO₂ | about 0.20:1 to about 0.26:1 |
| ROH:SiO₂ | about 0.06:1 to about 0.12:1 |
| H₂O:SiO₂ | about 7:1 to about 15:1 |

The gel composition formed in step viii of the method 1 in FIG. 1 may be subjected to hydrothermal conditions just after the preparation, or when desirable after undergoing a period of mixing, e.g., aging at a low temperature including, without limitation about room temperature or less than 100° C. over a period of ranging from about 5 minutes to 30 minutes hours. During production on a large scale, a deterioration in the mixing the raw materials may be undesirable, in that a sufficient state of admixture is necessary to achieve high yield and proper crystallization of the AEI-type zeolites.

Still referring to FIG. 1, during implementation of the method 1, the gel composition is subjected to heating 45 at predetermined crystallization temperature for a predetermined amount of time. This hydrothermal synthesis utilizes a crystallization temperature that is in the range from about 180° C. up to 220° C.; alternatively, between about 200° C. and about 220° C.; alternatively, from about 210° C. to about 220° C.; alternatively, about 220° C. The time period over which the temperature is maintained 50 in order to result in the crystallization and precipitation of the AEI zeolite is less than 2 hours; alternatively about 1 hour or less; alternatively less than or equal to 30 minutes.

Upon completion of the hydrothermal reaction, the AEI-type zeolite in the form of a crystalline precipitate is separated from remaining liquid (e.g., the mother liquid). The mother liquid may be discarded, or when desirable, reused as a replacement for at least a portion of the water that is used in the making of another batch of the AEI-type zeolite. This separation may use any known conventional method, including but not limited to, filtration, decantation, or direct drying (e.g., evaporation).

After separation from the mother liquid, the AEI-type zeolite, which may include some OSDA and/or alkali ions, may be collected, optionally washed with water, and then dried. The dried support material may be used in the dried state for some applications or subjected to calcination prior to use for other applications. Calcination of the AEI-zeolites at a high temperature (e.g., >2000; >3000, etc.) removes any residual OSDA present in the porous structure.

According to another aspect of the present disclosure, the dried AEI-type zeolites formed according to the process described above and further defined herein exhibits an average particle size that is less than 1 micrometer (□m); alternatively, less than 0.5 micrometers; alternatively, about 0.3 □m or less. The average particle size of the AEI-type zeolites may be measured using any known conventional method including, without limitation, laser diffraction, dynamic light scattering, and sieving.

The “dried” AEI-type zeolites formed herein may also exhibit a BET specific surface area that is greater than 500 m²/g; alternatively, at least 600 m²/g; alternatively, equal to or greater than 700 m²/g. The specific surface area of the AEI-type zeolites may be measured using a conventional Brunauer-Emmett-Teller (BET) method.

The morphology exhibited by the “dried” AEI-type zeolites may resemble cubes, square flakes, irregular particles, or a combination or mixture thereof. Alternatively, the morphology of the AEI-type zeolites resembles cubes, square flakes, or a mixture thereof.

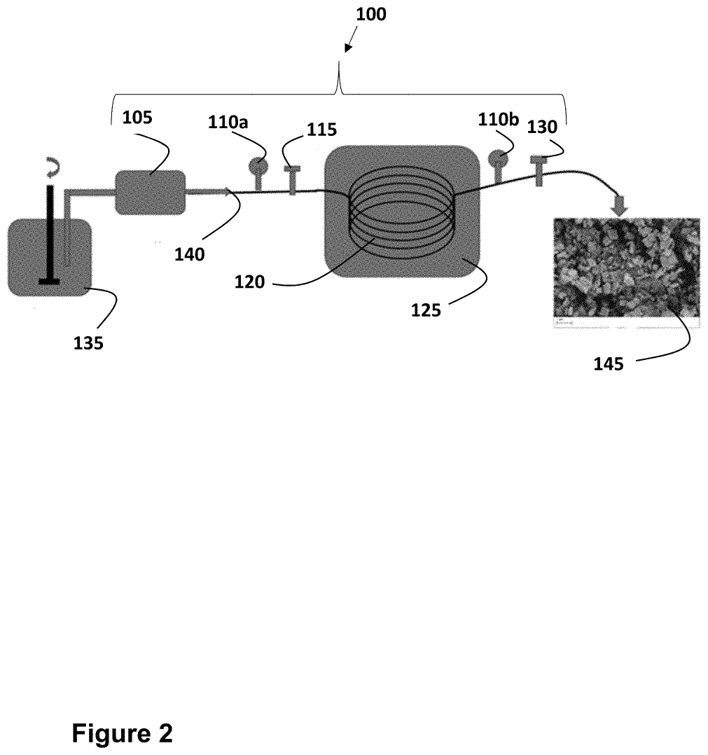

Referring now to FIG. 2, the tubular reactor 100 comprises a gel feeding pump 105, a first pressure gauge 110a and a second pressure gauge 110b, a safety valve 115, a coiled tube 120, an oil bath or pressurized water bath operating a temperature of 180° C. to 220° C., and a regulator 130. Each of the components in the tubular reactor 100 being in fluid communication with one another through a connecting tube 140. The first pressure gauge 110a is located at or near the inlet of the tubular reactor 100, while the second pressure gauge 110b is located at or near the outlet of the tubular reactor 100. The pressure gauges 110a, 110b monitor the pressure within the tubular reactor 100. The regulator 130 is configured such that it is capable of adjusting the pressure within the tubular reactor 100. In other words, the regulator 130 may be a back pressure regulator. Optionally, the tubular reactor 100 may include or be in fluid connection with a gel tank 135 capable of mixing the starting materials to form a gel.

Still referring to FIG. 2, the tubular reactor is generally operated within a temperature range of 180° C. to 220° C. The speed of the gel feeding pump 105 and the regulator 130 for controlling the gel slurry crystalline time in the tubular reactor 100 may be pre-adjusted or predetermined according to the diameter and length of the tube 140. A homogeneous gel composition or slurry is prepared according to a specific molar ratio and optionally seeded with AEI-type zeolite seeds. The gel composition is allowed to enter the tubular reactor 100. The speed through which the gel composition is allowed to proceed through the tubular reactor 100 may be controlled by adjusting the back pressure in the tubular reactor 100. The AEI-type zeolites and mother liquor is collected and separated forming a wetcake that is subsequently washed and dried to obtain the AEI-type zeolite 145.

According to another aspect of the present disclosure, a gel composition is provided that comprises a source of silica, a source of alumina, an organic structure directional agent (OSDA); a source of alkali metal ions, water, and optionally a small amount of an AEI-zeolite as a “seed”. The amount of each raw material present in the gel composition is provided relative to the amount of silica by the ratios shown in either Table 1 or Table 2. This gel composition after reacting at a temperature between 180° C. to about 220° C. for less than 2 hours forms a crystalline AEI-type zeolite having a silica to alumina (SiO₂:Al₂O₃) ratio that is greater than 14:1.

The use of the AEI-type zeolite formed according to the method of the present disclosure may include, without limitation, as a support material for a catalyst, an absorbent, or a separation material. The “dried” AEI-type zeolites may be used prior to or after calcination.

A catalyst may comprise the AEI-type zeolite with one or more catalytic metal ions exchanged for an atom in the framework or otherwise impregnated into the pores and/or cavities of the zeolite. Several examples of catalytic metal ions that may be incorporated into the AEI-type zeolite include, without limitation, ions of transition metals, platinum group metals (PGM), precious metals, such as gold or silver; alkaline earth metals, rare earth metals, or mixtures thereof. Transition metals may comprise, consist essentially of, or consist of copper, nickel, zinc, iron, tungsten, molybdenum, cobalt, titanium, zirconium, chromium, or tin. Platinum group metals may include, without limitation, ruthenium, rhodium, palladium, indium, and platinum. Alkaline earth metals include beryllium, magnesium, calcium, strontium, and barium. Rare earth metals include lanthanum, cerium, praseodymium, neodymium, europium, terbium, erbium, ytterbium, and yttrium.

The following specific examples are given to illustrate the disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

In the following examples, a HORIBA LA-920 laser particle sizer is used for the measurement of particle size distribution, a Rigaku MiniFlex II DESKTOP X-ray diffractometer is used for the measurement of phase and crystallinity, a Micromeritics TriStar II 3020 is used for the measurement of BET surface areas, a Spectro Analytical Instruments Model FCPSA83D ICP is used for analysis of chemical compositions, and zeolite morphology is measured using scanning electron microscopy (SEM).

### Example 1—Preparation & Characterization of a Batch of AEI-Type Zeolites Using a Tubular Reactor

The following ratios are used in this example: SiO₂/Al₂O₃=15:1 to 100:1; M₂O/SiO₂=0.15:1 to 0.30:1; ROH/SiO₂=0.06:1 to 0.12:1; and H₂O/SiO₂=7:1 to 15:1. The M was selected to be an alkali metal ion and R an organic moiety derived from the OSDA. A source of silica, alumina, organic structure directional agent (OSDA), alkali metal ions, and water were placed into a gel reactor and mixed in order to form a gel composition. The gel composition was then allowed to enter a tubular reactor wherein it was heated to a crystallization temperature in the range of 180° C. to 220° C. The gel composition was maintained at the crystallization temperature for less than 2 hours. During this reaction time, the AEI-type zeolite was observed to crystallize and precipitate, thereby forming a crystalline precipitate of the AEI-type zeolite and a mother liquid. The crystalline precipitate was then separated from the mother liquid.

The x-ray diffraction (XRD) pattern for the collected and dried zeolite was measured and found to show an AEI-type structure or framework being present. The measured XRD pattern further demonstrated that this AEI-type zeolite is substantially free of any other type of crystalline zeolite phase or structure such as the competing phase peaks of Analcime at 2e˜15.78°, 18.24°, 25.98° and Mordenite at 2e˜6.5°.

The morphology of the AEI-type zeolite was found using scanning electron microscopy to include predominantly cubes exhibiting an average size of less than one (1) micrometer.

The collected powder was calcined in a muffle furnace at a temperature in excess of 200° C. to remove any residual OSDA from the zeolite cage, The calcined powder was then subjected twice to an ion exchange process using ammonium chloride at room temperature for 1 hour. After the solid and liquid were separated the solid was washed in water then oven dried overnight to obtain an ammonia-form of AEI zeolites. A proton-form AEI zeolite may be obtained by performing calcination of the ammonia-form of the AEI zeolites at 450° C. for 16 hours.

Silica to alumina ratio (SAR) of the AEI-type zeolite formed in this example was measured using Inductively Coupled Plasma ICP. The SAR exhibited by the AEI-type zeolite was at least 14:1 with residual Na₂O present in an amount of 20 ppm or less.

The specific surface area (SA), pore volume (PV), and pore diameter (PD) was measured using a conventional Brunauer-Emmett-Teller (BET) method. The specific surface area of a fresh sample of the AEI-type zeolite was greater than 500 m²/g.

For the purpose of this disclosure, the terms “about” and “substantially” are used herein with respect to measurable values and ranges due to expected variations known to those skilled in the art (e.g., limitations and variability in measurements).

For the purpose of this disclosure any range in parameters that is stated herein as being “between [a 1^{st} number] and [a 2^{nd} number]” or “between [a 1^{st} number] to [a 2^{nd} number]” is intended to be inclusive of the recited numbers. In other words the ranges are meant to be interpreted similarly as to a range that is specified as being “from [a 1^{st} number] to [a 2^{nd} number]”.

For the purpose of this disclosure, the term “weight” refers to a mass value, such as having the units of grams, kilograms, and the like. Further, the recitations of numerical ranges by endpoints include the endpoints and all numbers within that numerical range. For example, a concentration ranging from 40% by weight to 60% by weight includes concentrations of 40% by weight, 60% by weight, and all concentrations there between (e.g., 40.1%, 41%, 45%, 50%, 52.5%, 55%, 59%, etc.).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A method of making an AEI-type zeolite, the method comprising the steps of:
a) providing a tubular reactor;
b) providing a source of silica;
c) providing a source of alumina;
d) providing an organic structure directional agent (OSDA);
e) providing a source of alkali metal ions;
f) providing a source of water;
g) optionally, providing a zeolite seed;
h) mixing the source of silica and alumina with the OSDA, the alkaline metal ions, and optionally the zeolite seed, with the water to form a gel composition;
i) allowing the gel composition to enter a tubular reactor;
j) heating the gel composition to a crystallization temperature that is in the range of about 180° C. to about 220° C.;
k) maintaining the gel composition at the crystallization temperature for a time period that is less than 2 hours;
l) allowing the AEI-type zeolite to crystallize and precipitate; the gel composition forming a crystalline precipitate of the AEI-type zeolite and a mother liquid; and
m) separating the crystalline precipitate from the mother liquid;
wherein the AEI-type zeolite has a silica to alumina (SiO₂:Al₂O₃) molar ratio of at least 14:1.

2. The method of claim 1, wherein the zeolite seed is an AEI zeolite seed present in an amount of 0% to about 10% relative to the amount of silica present in the AEI-type zeolite.

3. (canceled)

4. The method of claim 2, wherein the zeolite seed is present in an amount of 0.01% to about 1% relative to the amount of silica present in the AEI-type zeolite.

5. The method of claim 1, wherein the source of silica includes one selected from sodium silicate, silica sol, fumed silica, tetraethyl orthosilicate, a NaY and/or Y zeolite with a silica:alumina ratio (SAR) that is greater than 5 or a mixture thereof.

6. The method of claim 1, wherein the source of aluminum includes one selected from aluminum hydroxide aluminum sulfate, aluminum nitrate, FAU zeolites, or a mixture thereof.

7. The method of claim 1, wherein the organic structure directional agent (OSDA) is one selected from N, N-Dimethyl-3,5-dimethylpiperidinium hydroxide, N, N-Diethyl-2, 6-dimethylpiperidinium hydroxide, tetramethylphos-phonium hydroxide, or a mixture thereof.

8. The method of claim 1, wherein the alkali metal ions include one or more alkali metals (M); wherein M is one selected from sodium (Na), potassium (K), cesium (Cs), or a mixture thereof.

9. The method of claim 1, wherein the gel composition is further defined by a molar ratio for SiO₂/Al₂O₃ of 15:1 to 100:1; a molar ratio for M₂O/SiO₂ of 0.15:1 to 0.30:1; a molar ratio for ROH/SiO₂ of 0.06:1 to 0.12:1; and a molar ratio for H₂O/SiO₂ of 7:1 to 15:1;
wherein M is the alkali metal ion and R is an organic moiety derived from the OSDA.

10. The method of claim 1, wherein the molar ratio in the gel composition for SiO₂/Al₂O₃ is 20:1 to 60:1; for M₂O/SiO₂ is 0.20:1 to 0.26:1; for ROH/SiO₂ is 0.06:1 to 0.12:1; and for H₂O/SiO₂ is 7:1 to 15:1.

11. The method of claim 1, wherein the gel composition is heated in the tubular reactor to a crystallization temperature that is in the range of about 200° C. to about 220° C. and held at the crystallization temperature for a time period that is less than one hour.

12. (canceled)

13. The method of claim 1, wherein the molar ratio of silica to alumina (SiO₂:Al₂O₃) in the AEI-type zeolite is greater than or equal to 18.

14. The method of claim 1, wherein the molar ratio of silica to alumina (SiO₂:Al₂O₃) in the AEI-type zeolite is greater than or equal to 22.

15. The method of claim 1, wherein the AEI-type zeolite has an average particle size that is less than 1 micrometer as measured using scanning electron microscopy (SEM).

16. (canceled)

17. The method of claim 1, wherein the AEI-type zeolite has an average particle size that is less than 0.3 micrometer as measured using scanning electron microscopy (SEM).

18. The method of claim 1, wherein the AEI-type zeolite has a BET specific surface area that is greater than 500 m²/g.

19. (canceled)

20. The method of claim 1, wherein the AEI-type zeolite has a BET specific surface area that is greater than 700 m²/g.

21. The method of claim 1, wherein the AEI-type zeolite exhibits a morphology that includes one or more of cubes, square flakes, irregular particles, or a combination thereof.

22. An AEI-type zeolite prepared according to the method of claim 1.

23. A gel composition comprising the following components:
one or more sources of silica;
one or more sources of alumina,
one or more organic structure directing agents (OSDA);
an alkali metal ion;
optionally, a zeolite seed; and
water;
wherein a portion of the source of alumina is in the form of a FAU zeolite and a portion of the source of silica is a NaY and/or Y zeolite that has a silica to alumina (SiO₂:Al₂O₃) molar ratio of >5;
wherein the components in the gel composition are present in the following molar ratios:

| | |
|---|---|
| SiO₂/Al₂O₃ | 15:1 to 100:1; |
| M₂O/SiO₂ | 0.15:1 to 0.30:1; |
| ROH/SiO₂ | 0.05:1 to 0.2:1; and |
| H₂O/SiO₂ | 5:1 to 20:1; |

wherein M is the alkali metal ion and R is an organic moiety derived from the OSDA;
wherein the gel composition, after reacting at a temperature between 180° C. to about 220° C. for less than 2 hours in a tubular reactor forms a crystalline AEI-type zeolite having a molar silica to alumina ratio (SiO₂:Al₂O₃) that is greater than 14:1.

24. The gel composition of claim 23, wherein the components in the gel composition are present in the following molar ratios:

| | |
|---|---|
| SiO₂/Al₂O₃ | 20:1 to 60:1; |
| M₂O/SiO₂ | 0.20:1 to 0.26:1; |
| ROH/SiO₂ | 0.06:1 to 0.12:1; and |
| H₂O/SiO₂ | 7:1 to 15:1. |
